(19) United States
(12) Patent Application Publication
(10) Pub. No.: US 2026/0138401 A1
(43) Pub. Date: May 21, 2026

(54) TIRE CHANGER WHEEL LIFT MECHANISM

(71) Applicant: Hunter Engineering Company, Bridgeton, MO (US)

(72) Inventors: Alex GREENHILL, St. Charles, MO (US); William J. NELGNER, St. Charles, MO (US)

(21) Appl. No.: 19/480,308

(22) PCT Filed: May 12, 2025
(86) PCT No.: PCT/US2025/028887

§ 371 Date: Oct. 30, 2025

Related U.S. Application Data
(60) Provisional application No. 63/649,750, filed on May 20, 2024.

(51) Int. Cl. B60C 25/05; B60C 25/14

(52) U.S. Cl. CPC B60C 25/0521; B60C 25/0527; B60C 25/145

(57) ABSTRACT

A tire changer machine having a wheel lift mechanism including a lifting platform for receiving a wheel assembly consisting of a wheel rim and tire, and for elevation to and from a rotationally driven spindle. The wheel lift mechanism includes a pair of vertically adjustable horizontal wheel support rails located on opposite lateral sides of the rotationally driven spindle. An expansion mechanism is configured to further adjust a relative lateral spacing of the wheel support rails between minimum and maximum positions in response to one or more identified dimensions of the wheel assembly.

### CROSS-REFERENCE TO RELATED APPLICATIONS

The present application is related to, and claims priority from, co-pending U.S. Provisional Patent Application Ser. No. 63/649,750 filed on May 20, 2024, which is herein incorporated by reference.

### STATEMENT REGARDING FEDERALLY SPONSORED RESEARCH

Not Applicable.

### BACKGROUND OF THE INVENTION

The present invention is related generally to tire changer machines configured to facilitate mounting and demounting of tires from wheel rims, and in particular, to a wheel assembly lift mechanism utilized to aid an operator in lifting a tire and wheel assembly into position for attachment to a rotationally driven spindle.

Mounting and demount a tire from a wheel rim assembly is a common vehicle service procedure required any time a tire is replaced or repaired, and in some cases, during a routine tire rotation. The process requires forces to be exerted on the tire to pull the tire edges (beads) onto and off of the wheel rim, typically while the wheel rim is driven about an axis of revolution. To aid an operator in performing tire mounting and demounting procedures, a typical tire changer machine 10 such as shown in FIG. 1 includes a base, a tool support structure mounted on the base, a plurality of tire changing tools carried by the tool support structure, and a rotationally driven spindle assembly 12 onto which a wheel rim is temporarily secured, in proximity to the tire changing tools. These tool may include bead breakers 14, pushers 16, and tire hooks 18 which can be utilized to manipulate a tire onto or off of a wheel rim secured to the spindle assembly 12. During operation, either the tools are moved towards the wheel assembly secured to the spindle assembly 12, or the spindle assembly itself (and the secured wheel) is linearly moved towards a tool support structure 20.

Due to the weight of the combined tire and wheel rim in a wheel assembly, some tire changers 10 include a wheel lift mechanism 100 for aiding an operator in lifting and tilting a wheel assembly from the ground onto the rotationally driven spindle assembly 12. By necessity, the wheel lift mechanism 100 includes a lifting portion 102 which extends outward from a base 22 of the tire changer machine, and onto which the wheel assembly is initially placed in an upright orientation for elevation and tilting. The wheel lift mechanism 100 further includes additional elements such as fixed supports or roll rails 104 to aid in moving the wheel assembly from the lifting portion 102 onto the spindle 12 and back each time the lift mechanism 100 is utilized to raise or lower a wheel assembly.

When seating a new tire to a wheel rim secured to the rotationally driven spindle assembly 12, the uninflated tire sidewalls may sag or flex, causing the tire beads to fail to seat properly against a surface of the wheel rim. Often, it is necessary for an operator to manually lift or apply pressure to the tire sidewall surface on the lower side of the tire during an initial inflation to support the uninflated tire against the rim surfaces. The application of a lifting force or pressure on the lower tire sidewall surface aids in properly positioning the tire beads during the initial inflation of the tire, ensuring a proper seal between the tire beads and the wheel rim to retain the pressurized air being introduced to the tire.

Accordingly, it would be advantageous to provide a tire changer machine 10 with an improved tire lift mechanism capable of assisting an operator to apply pressure to support the sidewall surfaces of a wide range of uninflated tires to facilitate proper bead seating during an initial inflation operation, in addition to providing the functionality of lifting and lowering wheel assemblies to and from the rotationally driven spindle assembly.

### BRIEF SUMMARY OF THE INVENTION

The present invention sets forth a tire changer machine having a wheel lift mechanism including a lifting platform for receiving an wheel assembly consisting of a wheel rim and tire. The wheel lift mechanism is driven by a lifting mechanism to elevate and rotate the lifting platform towards a horizontal wheel mount location on the rotationally driven spindle of the tire changer machine. A pair of horizontal wheel support rails located on opposite lateral sides of the rotationally driven spindle facilitate transfer of the wheel assembly from the lifting mechanism to the wheel mount location. Each wheel support rail includes a set of rollers disposed along the longitudinal length of the rail, and is coupled to an elevating mechanism for adjustment of a vertical position relative to the wheel mounting surface. An expansion mechanism coupled between the support rails enables adjustment of a relative lateral spacing of the wheel support rails, ranging between a contracted position and an expanded position. The expansion mechanism is controlled in response to one or more identified dimensions of the wheel assembly, enabling the wheel support rails to engage the wheel assembly on the tire sidewalls as required.

A method of the present invention for utilizing the wheel support rails to facilitate a tire bead seating operation begins by laterally positioning the wheel support rails to accommodate the dimensions of the wheel assembly onto which the tire is to be mounted. The expansion mechanism is actuated to alter the relative lateral spacing of the wheel support rails to match the wheel rim diameter plus an offset distance. The offset distance ensures that the wheel support rails will only contact the sidewall of the tire, avoiding scratching the rim surface. In a preferred embodiment, the actuation of the expansion mechanism is carried out automatically, utilizing wheel rim diameter measurements collected via a vision system or other suitable measurement system. Alternatively, the action may be semi-automatic, relying upon an operator to provide a wheel rim dimension, or may be done manually in response to operator commands to expand or retract the wheel support rails. Once the wheel support rails are in the proper relative positions, the lifting mechanism is raised such that the lifting support rails contact a bottom sidewall of the tire. With the wheel support rails contacting the bottom sidewall surfaces of the tire, air is delivered to the tire via an inflation hose to seat the tire beads. After inflation is completed, the wheel support rails are fully lowered and retracted to a nominal position.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a prior art illustration of a tire changer having a wheel lift mechanism;

FIG. 2 is a perspective view of the wheel lift mechanism of the present disclosure in a lowered position;

FIG. 3 is a left side view of the wheel lift mechanism of FIG. 2;

FIG. 4 is a perspective view of the wheel lift mechanism of FIG. 2 in a raised position;

FIG. 5 is a left side view of the wheel lift mechanism of FIG. 5;

FIG. 76is a top view of a wheel lift mechanism of the present disclosure with the support rails in a contracted position; and

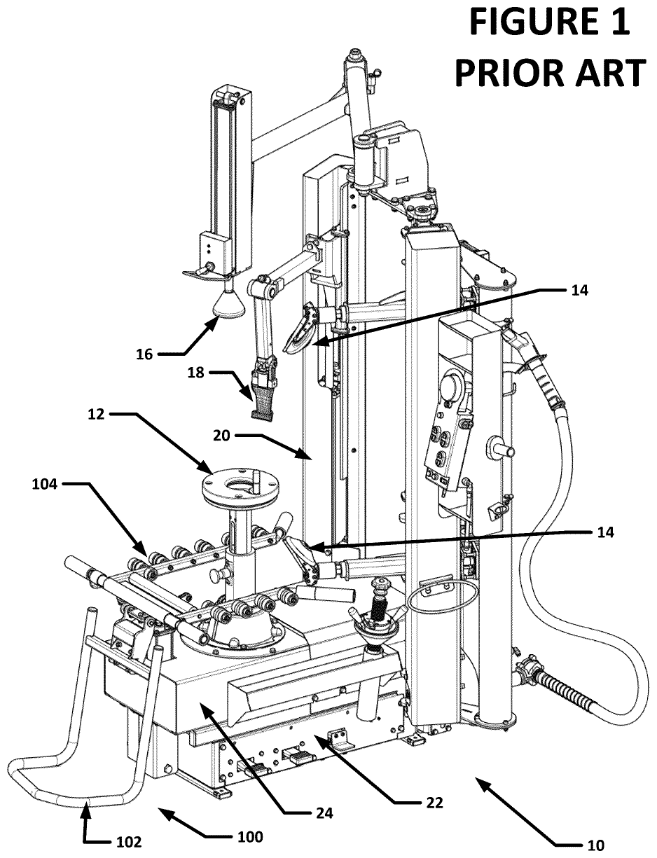

FIG. 7 is a top plan view of a wheel lift mechanism of the present disclosure with the support rails in an expanded position.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

While the embodiments set forth herein are shown and described as having components which are oriented horizontally, vertically, parallel to each other, and orthogonal to each other, those of ordinary skill in the art will recognize that the benefits and advantages of the present invention may be achieved using without rigid adherence to such positions and orientations. Accordingly, it will be understood that terms such as vertically, horizontally, parallel and orthogonal used to describe the positions and/or orientations of components are intended to encompass a range of positions and orientations which will enable the components to function as describe to lift, secure, position, and manipulate a wheel assembly rim and/or tire.

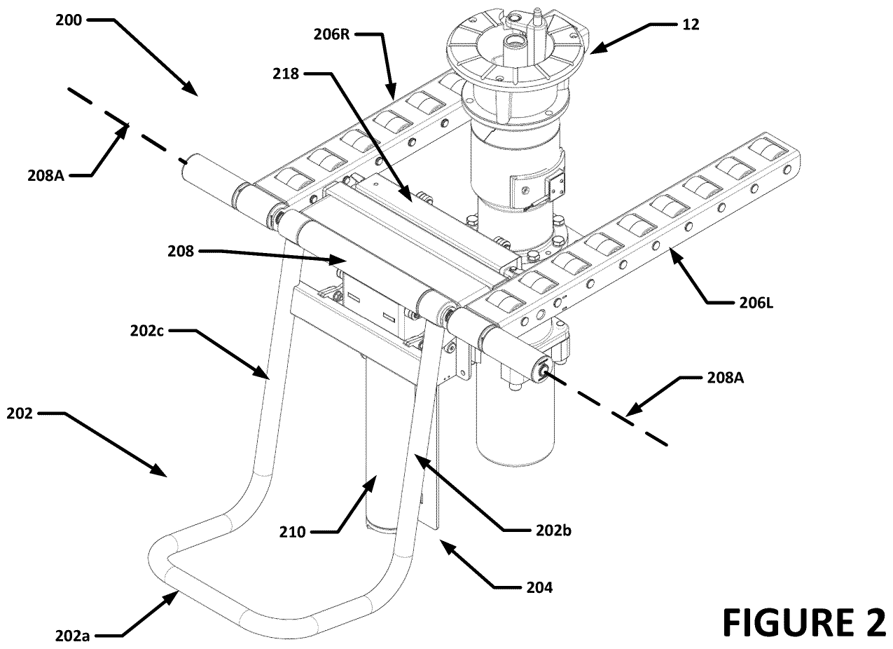

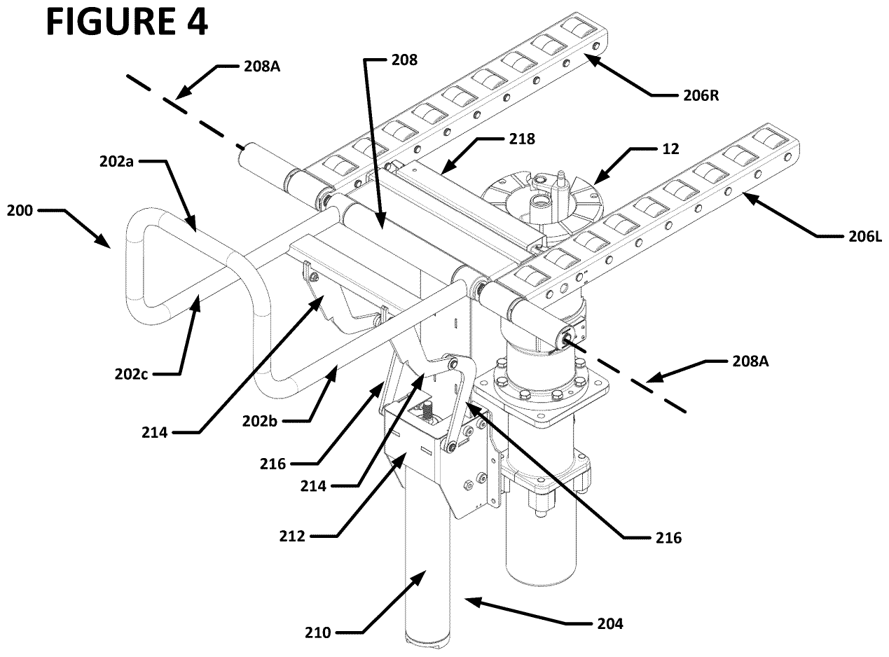

Turning to FIGS. 2 through 5, a wheel lift mechanism 200 of the present disclosure is shown and described in isolation from the working components and tools of a tire changer. The wheel lift mechanism 200 includes a wheel support 202 on which the wheel assembly is positioned for lifting and lowering, and a pair of horizontal wheel support rails 206L, 206R. In the embodiment as shown, the wheel support 202 is in the form of “U” shaped tubular structure, with the lower section 202a bent at approximately a right angle to the upright extensions 202b, 202c. In an exemplary alternate configuration, the wheel support 202 may take the form of a platform coupled to the upright extensions at an angle sufficient to be approximately horizontal when in a lowered position.

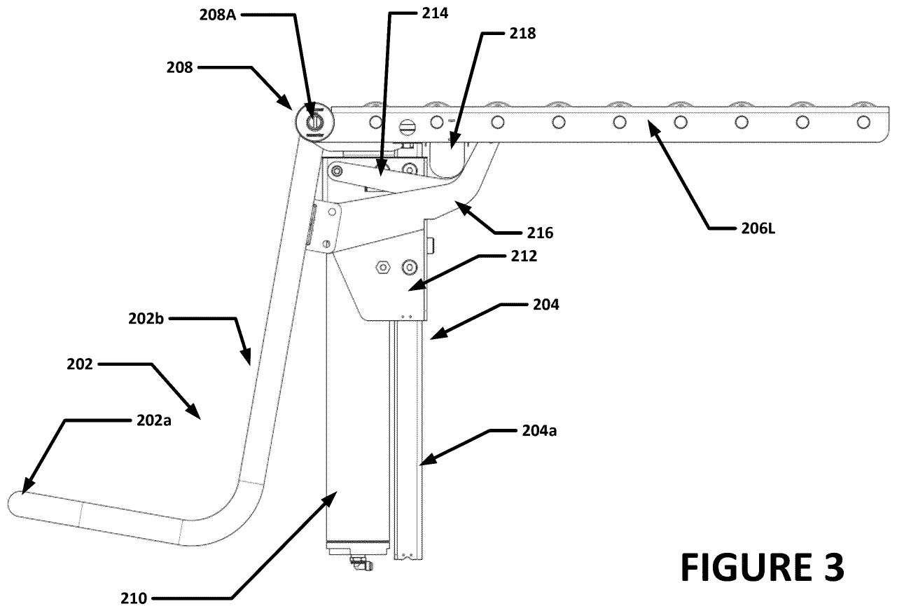

When in the lowered position, as shown in FIGS. 2 and 3, the lower section 202a of the wheel support 202 is located in close proximity to the floor surface, and is substantially parallel thereto, projecting away from the base of the tire changer 10, enabling an upright wheel assembly to be rolled onto the lower end of the wheel support 202. The upper end of each upright extension 202b, 202c of the wheel support 202 is coupled to a bar 208 having a longitudinal axis of rotation 208A. Alternatively, each upright extension 202b, 202c may be coupled to individual pins or couplings having a common axis of rotation 208A extending transverse to the wheel support 202 and parallel to the ground. As the wheel support 202 is rotated upward about the rotational axis 208A, a wheel assembly resting upright on the lower end 202a shifts to a position in which it is resting horizontally on the extensions 202b, 202c, enabling linear transfer onto the horizontal support rails 206L, 206R. Rotation of the wheel support 202 is regulated by a lifting mechanism 204 coupled to the upright extensions.

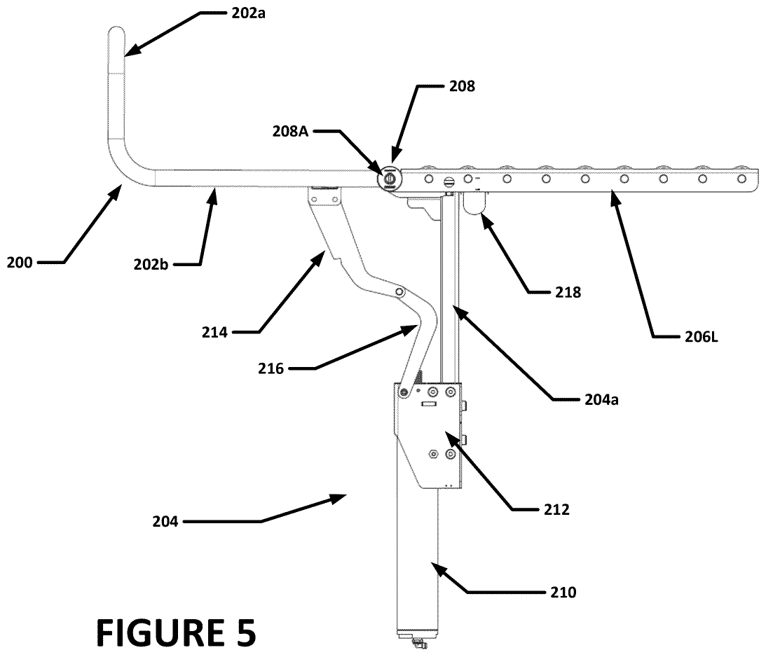

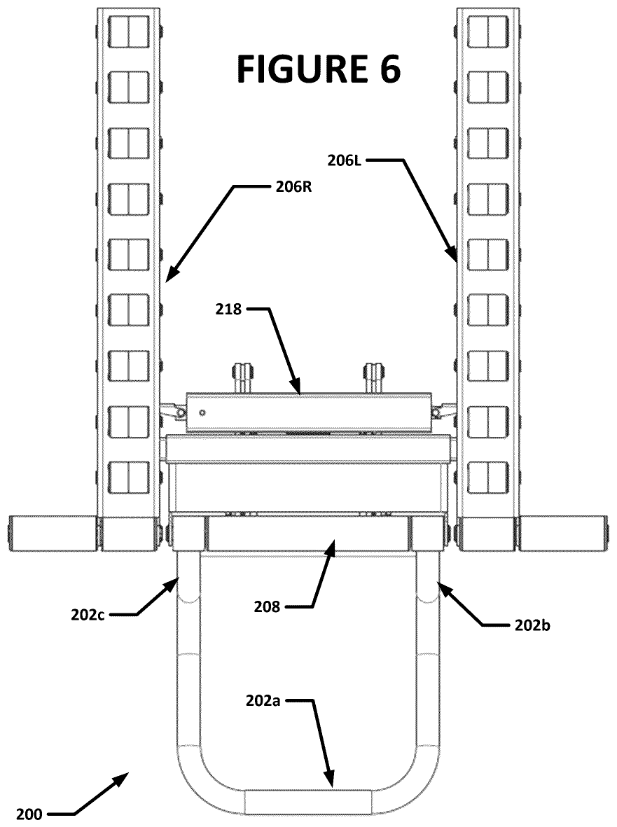

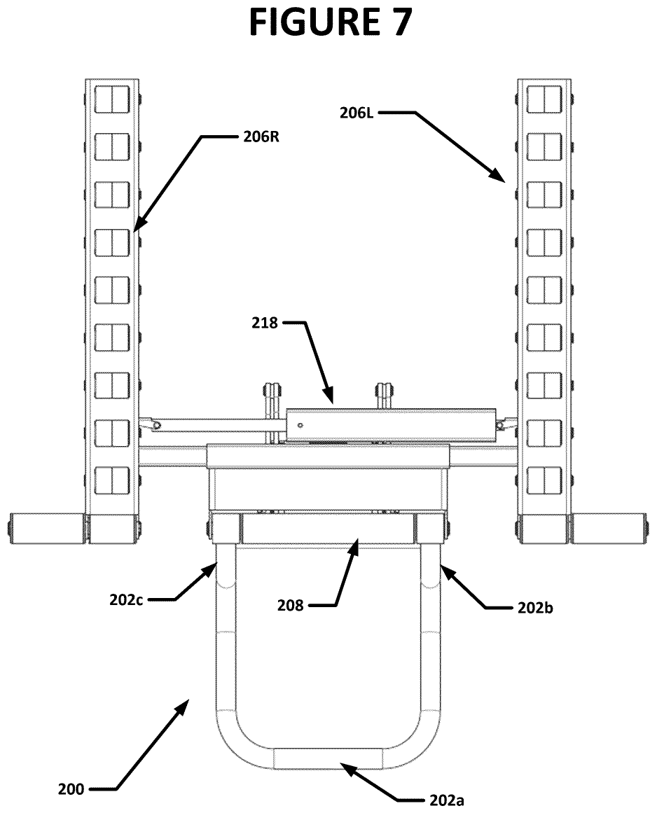

As shown in FIGS. 3 and 5, the lifting mechanism 204 includes a vertically-oriented arm or jack element 204a carried by a bracket 212 and coupled at one end to the bar 208 or to the individual pins or couplings for the upright extensions 202b, 202c. The arm or jack element 204a is linearly driven through the bracket 212 in a vertical direction by an actuation mechanism 210. The actuation mechanism 210 may be any suitable mechanism for imparting controlled bi-directional movement to the arm or jack element 204a in the vertical direction, such as a pneumatic cylinder or an electrically driven worm drive engaged with the arm or jack element 204a within the bracket 212. As the arm or jack element 204a is driven in a vertical direction, the bar 208 or individual pins or couplings are correspondingly raised or lowered, carrying the wheel support 202 and the horizontal support rails 206L and 206R. Arms 214 rigidly secured to each of the upright extensions 202b, 202c of the wheel support are pivotally connected to the fixed bracket 212 by associated pivot linkages 216. Motion of the arms 214 and pivot linkages 216 in response to changes in vertical positioning of the arm or jack element 204a result in rotational movement of the wheel support 202 about the longitudinal axis 208a of the bar 208 or the individual pins or couplings, transitioning the extensions 202b and 202c from a generally vertical orientation to a generally horizontal orientation approximately level with the horizontal support rails 206L, 206R as seen in FIG. 5. Downward movement of the jack element 204a reverses the rotational movement of the wheel support 202 about the rotational axis 208A of the bar 208 or individual pins or couplings.

In addition to moving vertically in response to movement of the arm or jack element 204a, the horizontal support rails 206L, 206R are configured for symmetrical lateral movement relative to each other as shown in FIGS. 6 and 7. A horizontally-oriented linear actuator 218 is coupled laterally between the support rails 206L, 206R. The linear actuator 218 may be pneumatically, hydraulically, mechanically or electrically driven. Expansion of the linear actuator 216 shifts the support rails 206L, 206R laterally outward towards an expanded position. Contraction of the linear actuator 218 reverses the direction of movement for the support rails 206L, 206R, drawing them laterally inward towards a retracted position. Extension springs associated with the linear actuator self-center the support rails during lateral movement, ensuring symmetrical relative displacement. Those of ordinary skill will recognize that the self-centering may alternatively be achieved by the use of a gear rack system or linkage coupling. In a preferred embodiment, the support rails 206L, 206R have a range of movement extending between a retracted position having a 14″ lateral separation, and an expanded position having a 22″ lateral separation. The range of lateral separation between the retracted and expanded positions of the support rails 206L, 206R is selected to accommodate a range of wheel diameters for which the tire changer 10 is intended to be utilized.

The wheel support rails 206L and 206R are utilized to facilitate a tire bead seating operation by adjusting the lateral separation to accommodate the dimensions of the wheel assembly onto which the tire is to be mounted. While the lifting mechanism 200 is in a lowered position, the linear actuator 218 is actuated to alter the relative lateral spacing of the wheel support rails 206L, 206R to match the wheel rim diameter plus an outward offset distance. The offset distance is set to ensure that the wheel support rails will only contact the rubber sidewall of the tire being installed on the wheel rim, thereby avoiding contact with, and potentially damaging the rim edge or surface. In a preferred embodiment, control of the linear actuator 218 is automatic via a controller or programmed processor of the tire changer 10, utilizing wheel rim diameter measurements collected via a vision system or other suitable measurement system. Alternatively, the action may be semi-automatic, relying upon an operator to input or set a wheel rim dimension for which the wheel support rails 206L, 206R are then positioned automatically by the controller or programmed processor, or may be done manually by expanding or retracting the separation of the wheel support rails 206L, 206R in response to operator input of movement commands, such as via a joystick, button, or foot-pedal.

Once the wheel support rails 206L, 206R are in the proper relative positions, the vertical arm or jack element 204a is engaged to elevate the wheel support rails into contact with a bottom sidewall of the tire to apply a selected upward force. If the actuation mechanism 210 imparting movement to the arm or jack element is a pneumatic cylinder, the applied upward force may be regulated by an application of continuous air pressure or by varied pulses of air timed to achieve a specific upward force. Similar control procedures may be utilized if the actuation mechanism is a hydraulic cylinder or linear actuator. Once the wheel support rails 206L, 206R are in contact with the bottom sidewall surfaces of the tire and the upward force is being applied, a flow of pressurized air is delivered to the tire via an inflation hose to seat the tire beads to the wheel rim. After inflation is completed, the wheel support rails 206L, 206R are fully lowered by the arm or jack element 204a and retracted laterally to a nominal separation position.

Some tire changer machines 10 provide a mechanism for controlled linear movement of the rotationally driven spindle 12 relative to a base, enabling the tire changer 10 to accommodate wheel assemblies of different sizes. Accordingly, the structure supporting the wheel lift mechanism 200 and the spindle 12 is secured to a spindle carriage 24 supported within the base 22. The spindle carriage 24 is configured for controlled linear movement relative to the tire changer tool support structure 20, along the longitudinal centerline of the base 22. Moving the spindle carriage 24 between a rearward position and a forward position enables the tire changer machine to position spindle-mounted wheel assemblies having different diameters within the operating range of the various tools 14, 16, 18 carried by the tool support structure 20. As the spindle carriage 24 is moved to reposition the spindle 12, the wheel lift mechanism 200 is maintained in a fixed relationship to the spindle 12, eliminating any need to reposition the spindle 12 prior to raising or lowering a wheel assembly onto the wheel support rails 204.

As various changes could be made in the above constructions without departing from the scope of the disclosure, it is intended that all matter contained in the above description or shown in the accompanying drawings shall be interpreted as illustrative and not in a limiting sense.

1. A tire changer machine, comprising:
a wheel lift having a lifting structure for receiving a wheel assembly, said wheel lift configured for conveying said wheel assembly between said lifting structure and a vertically-oriented rotationally driven spindle;
wherein said wheel lift mechanism includes a pair of vertically-adjustable horizontal wheel support rails located on opposite lateral sides of said rotationally driven spindle; and
further including an expansion mechanism configured to symmetrically adjust a relative lateral separation of said wheel support rails between contracted and expanded positions in response to at least one dimensions of said wheel assembly.

2. The tire changer machine of claim 1 further including an elevation mechanism coupled to said pair of horizontal wheel support rails, said elevation mechanism configured to apply a vertical force to said horizontal wheel support rails during a tire bead seating procedure for said wheel assembly.

3. The tire changer machine of claim 2 wherein said elevation mechanism is one of a pneumatic actuator a hydraulic actuator, or a mechanical actuator.

4. A wheel lift mechanism for a tire changer machine having a base a tool support structure mounted on the base, a plurality of tire changing tools carried by the tool support structure, and a spindle secured to said base, having an upper surface for securing a wheel assembly about a vertical axis of rotation, comprising:
an elevation mechanism secured to said base adjacent to said spindle, said elevation mechanism having a fixed bracket, an vertically-oriented arm, and an actuator configured to vertically move said arm relative to said bracket;
a wheel support having a lower section and an upper section oriented orthogonal to each other, said upper section connected to said fixed bracket by a pivot linkage and to said vertically oriented arm by at least one coupling configured for rotation about a horizontal axis;
a pair of horizontal wheel support rails secured in parallel to said vertically-oriented arm, aligned perpendicular to said at least one coupling;
wherein said lower section of said wheel support responds to vertical movement of said arm to lift and rotate a wheel assembly positioned on said lower section from a vertical orientation into a horizontal orientation on said upper section, aligned for placement onto said pair of wheel support rails;
wherein said vertically oriented arm has a range of vertical movement sufficient to elevate said wheel support rails from a minimum vertical position lower than said spindle upper surface, to a maximum vertical position higher than said spindle upper surface; and
wherein said pair of horizontal wheel support rails are laterally coupled by a horizontally-oriented linear actuator, whereby expansion and retraction of said linear actuator to alters a relative lateral separation therebetween.

5. The wheel lift mechanism of claim 4 wherein said relative lateral separation between said horizontal wheel support rails is set in response to at least one dimension of said wheel assembly.

6. The wheel lift mechanism of claim 5 wherein said at least one dimension is a measure of a wheel rim diameter.

7. The wheel lift mechanism of claim 4 wherein said horizontally-oriented linear actuator is a pneumatic, hydraulic, mechanical or electrical actuator.

8. The wheel lift mechanism of claim 4 wherein said horizontally-oriented linear actuator is operatively coupled to a control system, and wherein said control system is configured to operate said linear actuator to automatically set a relative lateral separation between said horizontal wheel support rails.

9. The wheel lift mechanism of claim 4 wherein said horizontally-oriented linear actuator is operatively coupled to a control system, and wherein said control system is configured to operate said linear actuator to set a relative lateral separation between said horizontal wheel support rails in response to an operator selection.

10. The wheel lift mechanism of claim 4 wherein said horizontally-oriented linear actuator is operatively coupled to an operator input, and wherein said linear actuator is configured to expand in response to a first signal from said operator input to expand, and to retract in response to a second signal from said operator input.

11. The wheel lift mechanism of claim 4 wherein said horizontal wheel support rails are symmetrically spaced relative to said spindle axis of rotation.

12. The wheel lift mechanism of claim 4 wherein said elevation mechanism is configured to selectively apply a vertical force to said horizontal wheel support rails.

13. A method for mounting an uninflated tire having inner and outer beads onto a wheel rim having inner and outer rim edges while the wheel rim is secured to a tire changer spindle comprising:
positioning said uninflated tire on said wheel rim with said inner and outer beads positioned between said inner and outer rim edges;
altering a relative lateral spacing of a pair of horizontal wheel support rails positioned vertically below said wheel rim and uninflated tire such that each horizonal wheel support rail is vertically aligned with a sidewall surface of said uninflated tire;
elevating said aligned horizontal wheel support rails into contact with said tire sidewall surface; and
applying a vertical force to said tire sidewall surface with said aligned horizontal wheel support rails during bead seating inflation of said tire.

14. The method of claim 13 wherein altering said relative lateral spacing of said pair of horizontal wheel support rails sets said relative lateral spacing at a distance greater than an outer diameter of said wheel rim and less than an outer diameter of said tire.

15. The method of claim 13 wherein altering said relative lateral spacing of said pair of horizontal wheel support rails sets said relative lateral spacing at a distance which exceeds an outer diameter of said wheel rim by an offset distance.

16. The method of claim 13 further including automatically acquiring at least a measurement of a diameter of said wheel rim; and
wherein said relative lateral spacing of said pair of horizontal wheel support rails is altered automatically to exceed said wheel rim diameter measurement.

17. The method of claim 13 further including receiving, from an operator input, at least a measurement of a diameter of said wheel rim; and
wherein said relative lateral spacing of said pair of horizontal wheel support rails is altered automatically to exceed said wheel rim diameter measurement.

18. The method of claim 13 wherein said relative lateral spacing of said pair of horizontal wheel support rails is altered in response to operator-input commands to expand and/or retract said wheel support rails.

19. The method of claim 13 wherein said application of vertical force to said tire sidewall surface by said aligned horizontal wheel support rails is removed following said bead seating inflation of said tire.

20. A method for operating a tire changing machine having a spindle configured to support a wheel assembly consisting of a wheel rim and tire for rotation about an axis, and a wheel lift structure including at least a pair of horizontally aligned wheel support rails positioned to facilitate transfer of said wheel assembly to and from said spindle, comprising:
securing said wheel assembly to said spindle;
altering a position of said pair of wheel support rails to engage only a sidewall surface of said tire; and
introducing a flow of pressurized air into said wheel assembly to expand said tire and to seat said tire to said rim while said pair of wheel support rails resist movement of said sidewall surface.
